(19) United States
(12) Patent Application Publication
(10) Pub. No.: US 2009/0231366 A1
(43) Pub. Date: Sep. 17, 2009

(54) IMAGE FORMING METHOD

(75) Inventors: Yoshimitsu Arai, Ashigarakami-gun (JP); Masao Ikoshi, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/397,508

(22) Filed: Mar. 4, 2009

(30) Foreign Application Priority Data
Mar. 12, 2008 (JP) 2008-063219

(51) Int. Cl. B41J 29/38

(52) U.S. Cl. 347/5

(57) ABSTRACT

An image forming method including: ejecting an ink containing a pigment, water, a water-soluble solvent and polymer particles onto a recording medium; and removing adhered ink solid from a nozzle face of a head that ejects the ink, wherein the ink satisfies the following Formula (1):

A_{d}/A_{w}≦0.1 Formula (1)
wherein, in Formula (1), A_{d} represents absorbance at λmax observed when 1 L of water is added to an ink residue obtained by drying 0.1 g of the ink for 24 hours in ambient conditions of 23° C. and relative humidity (RH) of 50%, and A_{w} represents absorbance at λmax observed when 1 L of water is added to 0.1 g of the ink.

### CROSS-REFERENCE TO RELATED APPLICATION

This application claims priority under 35 USC 119 from Japanese patent Application No. 2008-063219 filed on Mar. 12, 2008, the disclosure of which is incorporated by reference herein.

### BACKGROUND

1. Field of the Invention

The present invention relates to an image forming method using an inkjet system.

2. Description of the Related Art

With the rapid development of information technology industries in recent years, various information processing systems have been developed, and recording methods and recording apparatuses suitable for various information processing systems have also been used in practical applications. Among these, inkjet recording methods have come to be widely used due to advantages in terms of the range of recording media on which recording can be conducted, and in terms of the relatively low cost, compactness and low noise of the hardware (apparatus). Further, it is now possible to produce high-quality photo-like prints using inkjet recording methods.

In general, inkjet recording methods using pigment inks are considered to be superior to inkjet recording methods using dye inks in terms of the storage stability of the obtained prints. On the other hand, however, inkjet recording methods using pigment inks are also known to be inferior in terms of resistance to rubbing.

When pigment inks solidify due to evaporation of water in the inks, the solidified pigment inks do not re-dissolve and thus remain in a solidified state, which causes clogging at, for example, the tips of the nozzles of inkjet heads, leading to jetting failure. Further, when the inks solidify at a cap, a wiping section or the like, wiping or the like becomes difficult, thereby increasing the maintenance load.

An inkjet aqueous pigment ink has been disclosed (for example, in Japanese Patent Application Laid-Open (JP-A) No. 2004-107631) that aims to prevent the increase in maintenance (e.g., wiping) load caused by solidified ink and to provide excellent adhesiveness to paper. The inkjet aqueous pigment ink contains a pigment, water and a water-soluble organic solvent. When water evaporates from the inkjet aqueous pigment ink, the ink solidifies to form a solid, but the solid re-dissolves in inkjet aqueous pigment ink that is in a non-solidified state.

An inkjet recording apparatus has been disclosed (for example, in JP-A No. 2003-182093) that uses plural inks and aims to provide high cleaning efficiency by reducing the amount of residual ink on the nozzle face of the recording head after wiping. When the receding meniscus velocities (RMVs, mm/sec) of the plural inks used in the inkjet recording apparatus with respect to the nozzle face of the recording head are measured, the maximum value thereof RMVₘₐₓ and the minimum value thereof RMVₘᵢₙ are controlled so as to satisfy a specified relationship.

### SUMMARY OF THE INVENTION

However, even in the conventional technologies described above, there have been cases in which it is difficult to alleviate the maintenance load with respect to the nozzle face of the inkjet recording head while maintaining the resistance to rubbing of an image formed by the inkjet method. The present invention addresses the above problems. An object of the invention is to provide an image forming method that can alleviate the maintenance load with respect to the nozzle face of the inkjet head while maintaining the resistance to rubbing of a formed image.

An aspect of the present invention provides an image forming method including ejecting an ink containing a pigment, water, a water-soluble solvent and polymer particles onto a recording medium and removing adhered ink solid from a nozzle face of a head that ejects the ink, wherein the ink satisfies the following Formula (1):

A_{d}/A_{w}≦0.1 Formula (1)

In Formula (1), A_{d} represents an absorbance at λmax observed when 1 L of water is added to an ink residue obtained by drying 0.1 g of the ink for 24 hours in ambient conditions of 23° C. and relative humidity (RH) of 50%, and A_{w} represents absorbance at λmax observed when 1 L of water is added to 0.1 g of the ink.

A second aspect of the invention provides an image forming method according to the first aspect, wherein the removing includes wiping the nozzle face of the head with a wiper blade.

A third aspect of the invention provides an image forming method according to the first or second aspect, wherein a ratio (by mass) of the polymer particles to the pigment in the ink is 0.5 or higher.

A fourth aspect of the invention provides an image forming method according to any one of the first to third aspects, wherein at least 90% by mass of the water-soluble solvent is a solvent having an SP value of 27.5 or less.

A fifth aspect of the invention provides an image forming method according to any one of the first to fourth aspects, wherein the content of the water-soluble solvent is from 5% by mass to 30% by mass with respect to the total amount of the ink.

A sixth aspect ofthe invention provides an image forming method according to any one of the first to fifth aspects, wherein the glass transition temperature of the polymer particles is 80° C. or less.

A seventh aspect of the invention provides an image forming method according to any one of the first to sixth aspects, wherein, in the ejecting, the temperature of the ink is 30° C. or higher.

### DETAILED DESCRIPTION OF THE INVENTION

The image forming method according to the invention is described in detail below. The image forming method according to the invention includes ejecting an ink containing a pigment, water, a water-soluble solvent and polymer particles onto a recording medium and removing an adhered ink solid from a nozzle face of a head that ejects the ink. The ink satisfies the following Formula (1):

A_{d}/A_{w}≦0.1 Formula (1)

In Formula (1), A_{d} represents an absorbance at λmax observed when 1 L of water is added to an ink residue obtained by drying 0.1 g of the ink for 24 hours in ambient conditions of 23° C. and relative humidity (RH) of 50%, and A_{w} represents absorbance at λmax observed when 1 L of water is added to 0.1 g of the ink.

Since the ink used in the image forming method according to the invention includes polymer particles, the image formed by the method has excellent resistance to rubbing. The addition of the polymer particles to the ink also prevents interference between applied ink droplets caused by mixing of adjacent ink droplets and, therefore, a sharp image can be formed. However, the addition of the polymer particles to the ink makes it easier for an ink component to solidify and adhere to the nozzle face of the inkjet head. When the ink component adheres to the nozzle face, clogging and/or failure in ink droplet ejection easily occurs more frequently. Therefore, it is necessary to remove the ink component (adhered ink solid) adhered to the nozzle face. The method of removing the adhered ink solid may be, for example, rubbing (wiping) the nozzle face with, for example, cloth or a wiper blade. However, when the adhered ink solid is viscous, it may be difficult to remove the adhered ink solid with cloth, a wiper blade or the like. One reason why an adhered ink solid might become viscous is that the ink component adhering to the nozzle face re-dissolves when the ink component contacts the ink.

In consideration of the above situation, the image forming method according to the invention uses an ink containing an ink component that forms an adhered ink solid that does not easily re-dissolve. The adhered ink solid, therefore, can be easily scraped off as a solid, and the amount of the ink solid adhering to the nozzle face can be reduced. Consequently, maintenance of the nozzle face of the inkjet head can be facilitated. When the amount of the adhered ink solid is reduced, it is also possible to maintain the properties that have been imparted to the nozzle face, such as an ink-repelling property.

The ink used in the image forming method according to the invention satisfies Formula (1). The ratio, A_{d}/A_{w}, in Formula (1) is an index representing the ease of dissolution of an ink solid into the ink when the ink solid contacts the ink. A_{d} represents an absorbance at λmax observed when 1 L of water is added to an ink residue obtained by drying 0.1 g of the ink for 24 hours in ambient conditions of 23° C. and relative humidity (RH) of 50%. The ink residue obtained by drying the ink under these conditions can be regarded as an ink solid. Further, water can be regarded as an “ink” containing water as a main component. In other words, A_{d}/A_{w} represents the ratio of the ink solid that re-dissolves in the ink, and when the ratio, A_{d}/A_{w}, is 1, the ink solid completely dissolves in the ink. Since the ink used in the image forming method according to the invention has a ratio of A_{d}/A_{w} of 0.1 or lower, the ink solid does not easily re-dissolve when the ink solid contacts the ink, and the adhered ink solid can be easily scraped off as a solid.

The term, “λmax”, used herein refers to a wavelength at which an absorbance peak in the visible wavelength region is positioned. When there are plural peaks in the visible wavelength region, λmax refers to the peak wavelength having the maximum absorbance among the plural peaks. λmax can be measured using a commercially available spectral photometer. The measurement of λmax of the “ink residue” obtained by drying an ink under the specified conditions is conducted by adding the ink residue to 1 L of water, stirring the liquid for 30 minutes at room temperature, filtering the liquid through a 5-μm membrane filter, and measuring λmax of the filtrate.

The ink used in the image forming method according to the invention and components thereof are described below.

The ink used in the image forming method according to the invention includes a pigment, water, a water-soluble solvent and polymer particles. Since the ink used in the invention has such a composition, the liquid stability and jetting stability of the ink are improved, and curl of a recording medium after the ink is applied to the recording medium can be effectively suppressed.

The ink used in the invention can be used for a full color image formation. The ink may be used as at least one of, or each of, the inks for forming a full color image. In order to form a full color image, a magenta color ink, a cyan color ink, and a yellow color ink can be used. In order to adjust color tone, a black color ink may be used additionally. Other than yellow, magenta, and cyan color inks, at least one of a red ink, a green ink, a blue ink, a white ink, or an ink having a special color used in the field of printing may be used.

The ink used in the invention is preferably an aqueous ink. In particular, a water-dispersible pigment is preferably used as a color pigment.

Water-Soluble Solvent

The ink composition includes a water-soluble solvent that may serve as an anti-drying agent, a wetting agent, or a penetration accelerator. Here, the “water-soluble solvent” in the invention means a solvent of which 5 g or more can dissolve in 100 g of water.

In particular, when the ink composition of the invention is used as an aqueous ink composition for an inkjet recording system, a water-soluble organic solvent is preferably used as an anti-drying agent, a wetting agent, or a penetration accelerator.

At least one of the anti-drying agent or the wetting agent may be used for the purpose of preventing clogging at an ink ejection opening of a nozzle due to drying of the inkjet ink. As the anti-drying agent or the wetting agent, a water-soluble organic solvent with a lower vapor pressure than that of water is preferable.

Further, in view of facilitating infiltration of the ink into paper as a recording medium, a water-soluble organic solvent is preferably used as the penetration accelerator.

In the invention, in order to suppress a curl of a recording medium, the water-soluble solvent preferably contains a water-soluble solvent with an SP value of 27.5 or less at an amount of 90 mass % or more.

The solubility parameter (SP value) of a water-soluble solvent as described in the invention is a value expressed by the square root of the cohesive energy of molecules. SP values can be calculated by the method described in R. F. Fedors, Polymer Engineering Science, 14, pp. 147-154 (1974), which is incorporated herein by reference in its entirety. The values used in this invention are calculated by this method.

The water-soluble solvent may contain a compound represented by the following Structural Formula (1) for the purpose of further preventing the curl.

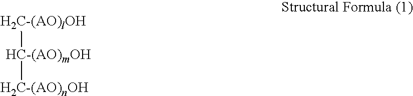

Here, the “water-soluble solvent with an SP value of 27.5 or less” may be the same as or different from the “compound represented by Structural Formula (1)”.

In Structural Formula (1), l, m and n each independently represent an integer of 1 or more, and the total of l, m and n is from 3 to 15.

When the total of l, m and n is less than 3, the ability to prevent curl of a recording medium becomes small, and when the total of l, m and n exceeds 15, the ink jetting property is deteriorated.

In particular, the total of l, m and n is preferably from 3 to 12, and more preferably from 3 to 10.

In Structural Formula (1), AOs each independently represent an ethyleneoxy group or a propyleneoxy group. In particular, a propyleneoxy group is preferable.

In an embodiment, l represents 1, or l represents an integer of 2 or more and plural AOs in (AO)ₗ are the same as each other; m represents 1, or m represents an integer of 2 or more and plural AOs in (AO)ₘ are the same as each other; and n represents 1, or n represents an integer of 2 or more and plural AOs in (AO)ₙ are the same as each other. In this particular embodiment, the AO in (AO)ₗ may be the same as or different from the AO in (AO)ₘ; the AO in (AO)ₗ may be the same as or different from the AO in (AO)ₙ; and the AO in (AO)ₘ may be the same as or different from the AO in (AO)ₙ.

Examples of water-soluble solvents having a SP value of 27.5 or less and the compound represented by Structural Formula (1) are shown below together with the SP values thereof (within the parentheses). However, the invention is not limited thereto.
diethyleneglycol monoethylether (22.4);
diethyleneglycol monobutylether (21.5);
triethyleneglycol monobutylether (21.1);
dipropyleneglycol monomethylether (21.3); and
dipropyleneglycol (27.2).

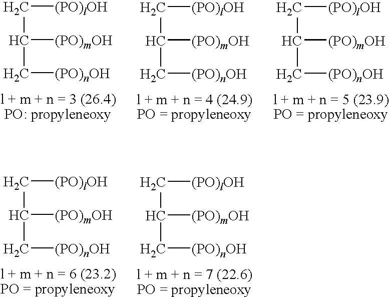

nC₄H₉O(AO)₄—H (AO=EO or PO (the ratio of EO:PO=1:1)) (20.1);
nC₄H₉O(AO)₁₀—H (AO=EO or PO (the ratio of EO:PO=1:1)) (18.8);
HO(A′O)₄₀—H (A′O=EO or PO (the ratio of EO:PO=1:3)) (18.7);
HO(A″O)₅₅—H (A″O=EO or PO (the ratio of EO:PO=5:6)) (18.8);
HO(PO)₃—H (24.7);
HO(PO)₇—H (21.2); and
1,2-hexanediol (27.4)

In the invention, EO and PO represent an ethyleneoxy group and a propyleneoxy group, respectively.

The ratio (content) of the compound represented by Structural Formula (I) in the water-soluble solvent is preferably 10 mass % or more, more preferably 30 mass % or more, and even more preferably 50 mass % or more. A higher content does not cause problems.

It is preferable that the content is within the above ranges, since the curl of the recording medium can be suppressed without deteriorating the ink stability and ink jetting property.

In the invention, at least one other additional solvent may be used together with the water-soluble solvent as long as the content of the water-soluble solvent with the SP value of 27.5 or less is 90 mass % or more.

Examples of the additional water-soluble organic solvent include polyhydric alcohols including glycerin, 1,2,6-hexanetriol, trimethylolpropane, and alkanediols such as ethyleneglycol, propyleneglycol, diethyleneglycol, triethyleneglycol, tetraethyleneglycol, pentaethyleneglycol, dipropyleneglycol, 2-butene-1,4-diol, 2-ethyl-1,3-hexanediol, 2-methyl-2,4-pentanediol, 1,2-octanediol, 1,2-hexanediol, 1,2-pentanediol, or 4-methyl-1,2-pentanediol; saccharides such as glucose, mannose, fructose, ribose, xylose, arabinose, galactose, aldonic acid, glucitol (sorbit), maltose, cellobiose, lactose, sucrose, trehalose or maltotriose; sugar alcohols; hyaluronic acids; so-called solid wetting agents such as ureas; alkyl alcohols having 1 to 4 carbon atoms such as ethanol, methanol, butanol, propanol or isopropanol;

glycol ethers such as ethyleneglycol monomethyl ether, ethyleneglycol monoethyl ether, ethyleneglycol monobutyl ether, ethyleneglycol monomethyl ether acetate, diethyleneglycol monomethyl ether, diethyleneglycol monoethyl ether, diethyleneglycol mono-n-propyl ether, ethyleneglycol mono-iso-propyl ether, diethyleneglycol mono-iso-propyl ether, ethyleneglycol mono-n-butyl ether, ethyleneglycol mono-t-butyl ether, diethyleneglycol mono-t-butylether, 1-methyl-1-methoxybutanol, propyleneglycol monomethyl ether, propyleneglycol monoethyl ether, propyleneglycol mono-t-butyl ether, propyleneglycol mono-n-propyl ether, propyleneglycol mono-iso-propyl ether, dipropyleneglycol monomethyl ether, dipropyleneglycol monoethyl ether; dipropyleneglycol mono-n-propyl ether or dipropyleneglycol mono-iso-propyl ether; 2-pyrrolidone, N-methyl 2-pyrrolidone, 1,3-dimethyl-2-imidazolidinone, formamide, acetamide, dimethylsulfoxide, sorbit, sorbitan, acetin, diacetin, triacetin, and sulfolane. The additional water-soluble organic solvent may be used singly, or in combination of two or more thereof.

When the additional water-soluble organic solvent is used for the purpose of an anti-drying agent or a wetting agent, the additional water-soluble organic solvent is preferably a polyhydric alcohol, and examples thereof include glycerin, ethyleneglycol, diethyleneglycol, triethyleneglycol, propyleneglycol, dipropyleneglycol, tripropyleneglycol, 1,3-butanediol, 2,3-butanediol, 1,4-butanediol, 3-methyl-1,3-butanediol, 1,5-pentanediol, tetraethyleneglycol, 1,6-hexanediol, 2-methyl-2,4-pentanediol, polyethylene glycol, 1,2,4-butanetriol, and 1,2,6-hexanetriol. The additional water-soluble organic solvent as an anti-drying agent or a wetting agent may be used singly, or in combination of two or more thereof.

When the additional water-soluble organic solvent is used for the purpose of a penetrating agent, the additional water-soluble organic solvent is preferably a polyol compound. Examples of the polyol compound include aliphatic diols such as 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol, 2-ethyl-1,3-hexanediol, 2,2,4-trimethyl-1,3 -pentanediol or 2,2,4-trimethyl-1,3-pentanediol. Among these compounds, 2-ethyl-1,3-hexanediol and 2,2,4-trimethyl-1,3-pentanediol are preferable.

The water-soluble solvent used in the invention may be used singly, or two or more kinds thereof may be mixed and used.

From the viewpoint of maintaining the stability and jetting reliability of ink, the content of the water-soluble solvent is preferably from 1 mass % to 60 mass %, more preferably from 5 mass % to 40 mass %, and particularly preferably from 5 mass % to 30 mass %, with respect to the total amount of the ink composition.

Although the addition amount of water used for the invention is not particularly limited, from the viewpoint of maintaining the stability and jetting reliability of ink, the addition amount of water is preferably from 10 mass % to 99 mass %, more preferably from 30 mass % to 80 mass %, and even more preferably from 50 mass % to 70 mass %, with respect to the total amount of the ink composition.

Pigment

The pigment used in the invention is not specifically limited, and may be appropriately selected depending on the purposes. For example, the pigment may be either an organic pigment or an inorganic pigment, or both.

Examples of the organic pigment include azo pigments, polycyclic pigments, dye chelates, nitro pigments, nitroso pigments and aniline black. In particular, azo pigments and polycyclic pigments are preferable.

Examples of the azo pigments include an azo lake pigment, an insoluble azo pigment, a condensed azo pigment, and a chelate azo pigment.

Examples of the polycyclic pigments include a phthalocyanine pigment, a perylene pigment, a perynone pigment, an anthraquinone pigment, a quinacridone pigment, a dioxazine pigment, an indigo pigment, a thioindigo pigment, an isoindolinone pigment, and a quinofraron pigment.

Examples of the dye chelates include basic dye chelate pigments and acid dye chelate pigments.

Examples of the inorganic pigments include titanium oxide, iron oxide, calcium carbonate, barium sulfate, aluminum hydroxide, barium yellow, cadmium red, chrome yellow, and carbon black. Among these pigments, carbon black is particularly preferable. The carbon black may be, for example, a carbon black manufactured by a known method such as a contact method, a furnace method or a thermal method.

Examples of black pigments include carbon blacks such as RAVEN 7000, RAVEN 5750, RAVEN 5250, RAVEN 5000 ULTRAII, RAVEN 3500, RAVEN 2000, RAVEN 1500, RAVEN 1250, RAVEN 1200, RAVEN 1190 ULTRAII, RAVEN 1170, RAVEN 1255, RAVEN 1080, RAVEN 1060 or RAVEN700 (trade names, manufactured by Columbian Chemicals Co.); REGAL 400R, REGAL 330R, REGAL 660R, MOGUL L, BLACK PEARLS L, MONARCH 700, MONARCH 800, MONARCH 880, MONARCH 900, MONARCH 1000, MONARCH 1100, MONARCH 1300 or MONARCH 1400 (trade names, manufactured by Cabot Corporation); COLOR BLACK FW1, COLOR BLACK FW2, COLOR BLACK FW2V, COLOR BLACK 18, COLOR BLACK FW200, COLOR BLACK S150, COLOR BLACK S160, COLOR BLACK S170, PRINTEX 35, PRINTEX U, PRINTEX V, PRINTEX 140U, PRINTEX 140V, SPECIAL BLACK 6, SPECIAL BLACK 5, SPECIAL BLACK 4A or SPECIAL BLACK 4 (trade names, manufactured by Degussa); No. 25, No. 33, No. 40, No. 45, No. 47, No. 52, No. 900, No. 2200B, No. 2300, MCF-88, MA600, MA7, MA8 or MA100 (trade names, manufactured by Mitsubishi Chemical Corporation). However, in the invention, the black pigments are not limited thereto.

Organic pigments usable in the invention include yellow ink pigments such as C. I. Pigment Yellow 1, 2, 3, 4, 5, 6,7, 10, 11, 12, 13, 14, 14C, 16, 17, 24, 34, 35, 37, 42, 53, 55, 65, 73, 74, 75, 81, 83, 93, 95, 97, 98, 100, 101, 104, 108, 109, 110, 114, 117, 120, 128, 129, 138, 150, 151, 153, 154, 155 or 180.

Organic pigments usable in the invention further include magenta ink pigments such as C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48 (Ca), 48 (Mn), 48:2, 48:3, 48:4, 49, 49:1, 50, 51, 52, 52:2, 53:1, 53, 55, 57 (Ca), 57:1, 60, 60:1, 63:1, 63:2, 64, 64:1, 81, 83, 87, 88, 89, 90, 101 (iron oxide red), 104, 105, 106, 108 (cadmium red), 112, 114, 122 (quinacridone magenta), 123, 146, 149, 163, 166, 168, 170, 172, 177, 178, 179, 184, 185, 190, 193, 202, 209, 219, 269 or C.I. pigment violet 19. Among these pigments, C.I. pigment red 122 is particularly preferable.

Furthermore, organic pigments usable in the invention further include cyan ink pigments such as C.I. Pigment Blue 1, 2, 3, 15, 15:1, 15:2, 15:3, 15:34, 16, 17:1, 22, 25, 56, 60, C.I. Bat Blue 4, 60 or 63. Among these pigments, C. I. Pigment Blue 15:3 is particularly preferable.

The pigment may be used singly or in combination of two or more thereof, each of which may be selected from the above classes of pigments and may belong to the same class as each other or different classes from each other.

The pigment used in the invention is preferably selected from the following water-dispersible pigments (1) to (4), from the viewpoint of the liquid stability and liquid jetting stability.

### Water Dispersible Pigment

Examples of the water dispersible pigment include the following classes (1) to (4):

(1) An encapsulated pigment, that is, a polymer emulsion formed by incorporating a pigment into polymer particles; more specifically, in the polymer emulsion, pigment particles are dispersed in water and have a resin layer formed of a hydrophilic water-insoluble resin that covers the surfaces of the pigment particles and imparts hydrophilicity to the pigment particles;

(2) A self-dispersing pigment, that is, a pigment having at least one type of hydrophilic group on a surface thereof and exhibiting at least one of water-dispersibility or water-solubility in the absence of a dispersant; more specifically, the pigment is prepared by subjecting the surfaces of pigment particles (such as carbon black particles) to an oxidizing treatment so as to impart hydrophilicity to the pigment particles and so as to enable the pigment itself to disperse in water;

(3) A resin dispersed pigment, that is, a pigment dispersed using a water-soluble polymer compound having a weight average molecular weight of 50,000 or less; and

(4) A surfactant-dispersed pigment, that is, a pigment dispersed using a surfactant.

Among these pigments, (1) an encapsulated pigment and (2) a self-dispersing pigment are preferable, and (1) an encapsulated pigment is particularly preferable.

In the following, the encapsulated pigment will be described in detail.

The resin used in the encapsulated pigment is not specifically limited, but is preferably a polymer compound that is self-dispersible or dissolvable in a mixed solvent of water and a water-soluble organic solvent and that has an anionic (acidic) group. In general, the number average molecular weight of the resin is preferably in the range of about 1000 to about 100,000, and particularly preferably in the range of about 3000 to about 50,000. The resin is preferably a resin that can dissolve in an organic solvent to form a solution. When the number average molecular weight of a resin is within the above ranges, the resin can exhibit sufficient function as a cover layer on pigment particles or as a coated layer on an ink component in an ink. The resin is preferably used in the form of an alkali metal salt or an organic amine salt.

The resin used for the encapsulated pigment may be, for example, a material having an anionic group, and examples thereof include thermoplastic, thermosetting, or modified resins of the following types of resin: an acrylic resin, an epoxy resin, a polyurethane resin, a polyether resin, a polyamide resin, an unsaturated polyester resin, a phenol resin, a silicone resin, a fluoropolymer compound; a polyvinyl resin such as polyvinyl chloride, polyvinyl acetate, polyvinyl alcohol or polyvinyl butyral; a polyester resin such as an alkyd resin or a phthalic acid resin; an amino resin such as a melamine resin, a melamine-formaldehyde resin, an aminoalkid co-condensed resin, a urea formaldehyde resin, or a urea resin; and copolymers and mixtures of two or more of these resins.

Of the above resins, an anionic acrylic resin can be obtained, for example, by polymerizing, in a solvent, an acrylic monomer having an anionic group (hereinafter, referred to as an anionic group-containing acrylic monomer) and, optionally, one or more other monomers copolymerizable with the anionic group-containing acrylic monomer. Examples of the anionic group-containing acrylic monomer include an acrylic monomer having one or more anionic groups selected from the group consisting of a carboxylic group, a sulfonic acid group and a phosphonic group. Among these monomers, an acrylic monomer having a carboxyl group is preferable.

Examples of the acrylic monomer having a carboxyl group include acrylic acid, methacrylic acid, crotonic acid, ethacrylic acid, propylacrylic acid, isopropylacrylic acid, itaconic acid and fumaric acid. Among these monomers, acrylic acid and methacrylic acid are preferable.

An encapsulated pigment can be manufactured by a conventional physical and/or chemical method by using the above components. According to a preferable embodiment of the invention, the encapsulated pigment can be manufactured by the methods described in JP-A Nos. 9-151342, 10-140065, 11-209672, 11-172180, 10-25440, or 11-43636.

In the present invention, a self-dispersing pigment is an example of a preferable pigment. A self-dispersing pigment is a pigment in which a number of hydrophilic functional groups and/or a salt thereof (hereinafter, referred to as a dispersibility-imparting group) are directly or indirectly (via an alkyl group, an alkyl ether group, an aryl group or the like) bonded to the surfaces of particles of the pigment, so that the pigment particles can be dispersed in an aqueous medium without a dispersant. Here, the term “dispersed in an aqueous medium without a dispersant”, indicates a state in which the pigment particles are dispersible in the aqueous medium even when a dispersant for dispersing the pigment is not used.

An ink containing a self-dispersing pigment as a colorant does not need to contain a dispersant, which is otherwise contained for dispersing a usual pigment. Therefore, the ink containing a self-dispersing pigment is free from decrease in defoaming properties due to a dispersant, and generation of foam is hardly observed in the ink containing a self-dispersing pigment; accordingly an ink with excellent ink jetting stability can be easily prepared.

Examples of dispersibility-imparting groups to be bonded to the surfaces of self-dispersing pigment particles include —COOH, —CO, —OH, —SO₃H, —PO₃H₂, and a quaternary ammonium, and salts thereof. A self-dispersing pigment can be manufactured by subjecting a pigment as a raw material to a physical or chemical treatment so as to bond (graft) a dispersibility-imparting group or an active species having a dispersibility-imparting group to the surfaces of the pigment particles. Examples of the physical treatment include a vacuum plasma treatment. Examples of the chemical treatment include a wet oxidizing method in which surfaces of pigment particles are oxidized by an oxidizing agent in water and a method in which p-aminobenzoic acid is bonded to surfaces of pigment particles whereby a carboxyl group is linked to the pigment particles through the phenyl group.

In the invention, preferable examples of the self-dispersing pigment include a self-dispersing pigment whose surface has been subjected to an oxidation treatment with a hypohalous acid and/or hypohalite and a self-dispersing pigment whose surface has been subjected to an oxidation treatment with ozone. Commercially available products may also be used as the self-dispersing pigment. Examples thereof include, MICROJET CW-I (trade name, manufactured by Orient Chemical Industry), and CAB-O-JET200 and CAB-O-JET300 (trade names, manufactured by Cabot Corporation).

In the invention, the content of the pigment is preferably from 0.1 mass % to 15 mass %, more preferably from 0.5 mass % to 12 mass %, and particularly preferably from 1 mass % to 10 mass %, with respect to the total amount of the ink, in consideration of coloring properties, graininess, ink stability and ink jetting reliability.

Dispersant

In the invention, the dispersant used in an encapsulated pigment or a resin dispersed pigment may be selected from a nonionic compound, an anionic compound, a cationic compound, or an amphoteric compound.

The dispersant is, for example, a copolymer formed from monomers having an α,β-ethylenic unsaturated group. Examples of the monomers having an α,β-ethylenic unsaturated group include ethylene, propylene, butene, pentene, hexene, vinyl acetate, allyl acetate, acrylic acid, methacrylic acid, crotonic acid, a crotonic acid ester, itaconic acid, an itaconic acid monoester, maleic acid, a maleic acid monoester, a maleic acid diester, fumaric acid, a fumaric acid monoester, vinyl sulfonic acid, styrene sulfonic acid, sulfonated vinyl naphthalene, vinyl alcohol, acrylamide, methacryloxy ethyl phosphate, bismethacryloxyethyl phosphate, methacryloxyethylphenyl acid phosphate, ethyleneglycol dimethacrylate, diethyleneglycol dimethacrylate, styrene, styrene derivatives such as α-methyl styrene or vinyltoluene; vinyl cyclohexane, vinyl naphthalene, vinyl naphthalene derivatives, an alkyl acrylate which may have an aromatic substituent, phenyl acrylate, an alkyl methacrylate which may have an aromatic substituent, phenyl methacrylate, a cycloalkyl methacrylate, an alkyl crotonate, a dialkyl itaconate, a dialkyl maleate, vinyl alcohol, and derivatives of the above compounds.

A homopolymer formed by polymerization of one kind of monomer having an α,β-ethylenic unsaturated group, which may be selected from the above monomers, or a copolymer formed by copolymerization of plural kinds of monomer having an α,β-ethylenic unsaturated group, each of which may be selected from the above monomers, may be used as a polymer dispersant.

Examples of the dispersant include an alkyl acrylate-acrylic acid copolymer, an alkyl methacrylate-methacrylic acid copolymer, a styrene-alkyl acrylate-acrylic acid copolymer, styrene-phenyl methacrylate-methacrylic acid copolymer, a styrene-cyclohexyl methacrylate-methacrylic acid copolymer, a styrene-styrene sulfonic acid copolymer, a styrene-maleic acid copolymer, a styrene-methacrylic acid copolymer, a styrene-acrylic acid copolymer, a vinyl naphthalene-maleic acid copolymer, a vinyl naphthalene-methacrylic acid copolymer, a vinyl naphthalene-acrylic acid copolymer, polystyrene, a polyester, and polyvinyl alcohol.

Among these dispersants, the following resin (A) is preferable as a dispersant.

Resin (A)

The resin (A) is used as a dispersant for dispersing the pigment in the ink.

The resin (A) includes hydrophobic structural units (a) and hydrophilic structural units (b). If needed, the resin (A) may include structural units (c) that are different from both of the hydrophobic structural units (a) and the hydrophilic structural units (b).

While the composition of the hydrophobic structural units (a) and the hydrophilic structural units (b) varies with the degree of the hydrophilicity of the structural units (b) or the hydrophobicity of the structural units (a), the content of hydrophobic structural units (a) is preferably in excess of 80 mass %, and more preferably 85 mass % or more, with respect to the total mass of the resin (A). That is, the content of the hydrophilic structural units (b) is preferably less than 20 mass %, and more preferably 15 mass % or less. When the content of the hydrophilic structural units (b) is 20 mass % or more, the amount of components independently dissolving in an aqueous liquid medium without contributing to the dispersion of the pigment increases, so that various characteristics, such as dispersibility, of the pigment are deteriorated, resulting in deterioration in the ink jetting property of the ink.

Hydrophobic Structural Units (a)

In the resin (A) of the invention, the hydrophobic structural units (a) include at least a hydrophobic structural unit (al) having an aromatic ring which is not directly bonded to an atom belonging to the main chain of the resin (A).

Here, “not directly bonded to” means a structure in which the aromatic ring is linked to an atom belonging to the main chain structure of the resin through a linking group. Since such a structure maintains an adequate distance between the hydrophobic aromatic ring and a hydrophilic structural unit in the resin (A), an interaction between the resin (A) and the pigment is enhanced, whereby the resin (A) is firmly adsorbed to the pigment and the dispersibility of the pigment is improved.

Hydrophobic Structural Unit (a1) Having Aromatic Ring

The content of the hydrophobic structural unit (a1) having an aromatic ring which is not directly bonded to an atom belonging to the main chain of the resin (A), is preferably from 40 mass % to less than 75 mass %, more preferably from 40 mass % to less than 70 mass %, and particularly preferably from 40 mass % to less than 60 mass %, with respect to the total mass of the resin (A), in consideration of the dispersion stability of the pigment, the jetting stability and the washability.

When the content of the hydrophobic structural unit (a1) including the aromatic ring is in the above range, resistance to rubbing, ink stability and ink ejection reliability can be enhanced.

The content of the aromatic ring which is not directly bonded to an atom belonging to the main chain of the resin (A) is preferably from 15 mass % to 27 mass %, more preferably from 15 mass % to 25 mass %, and particularly preferably from 15 mass % to 20 mass %, with respect to the total amount of the resin (A), from the viewpoint of improving resistance to rubbing.

When the content of the aromatic ring in the unit (a1) are in the above ranges, resistance to rubbing, ink stability and ink ejection reliability can be enhanced.

In the invention, the hydrophobic structural unit (a1) containing the aromatic ring in the hydrophobic structural units (a) is preferably included in the resin (A) by taking a structure represented by the following Formula (2);

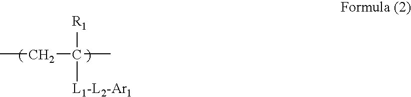

In Formula (2), R₁ represents a hydrogen atom, a methyl group or a halogen atom, L₁ represents —COO—, —OCO—, —CONR₂—, —O—, or a substituted or unsubstituted phenylene group wherein the left side in each structure corresponds to the main chain side, and R₂ represents a hydrogen atom or an alkyl group having 1 to 10 carbon atoms. L₂ represents a single bond or a divalent linking group having 1 to 30 carbon atoms. If L₂ represents a divalent linking group, the linking group preferably has 1 to 25 carbon atoms, and particularly preferably has 1 to 20 carbon atoms. Here, examples of the substituent include, but are not limited to, a halogen atom, an alkyl group, an alkoxy group, a hydroxyl group, and a cyano group. Ar₁ represents a monovalent group derived from an aromatic ring.

In Formula (2), a combination is preferable in which R₁ represents a hydrogen atom or a methyl group, L₁ represents —COO— (the left side of the chemical formula representing the main chain side), and L₂ represents a divalent linking group having 1 to 25 carbon atoms and containing an alkyleneoxy group and/or an alkylene group. A combination is more preferable in which R₁ represents a hydrogen atom or a methyl group, L₁ represents —COO— (the left side of the chemical formula representing the main chain side), and L₂ represents —(CH₂—CH₂—O)ₙ— (where n represents the average number of repeating units and is from 1 to 6, the left side of the chemical formula representing the main chain side).

The aromatic ring of Ar₁ contained in the hydrophobic structural unit (a1) is not particularly limited, and examples thereof include a benzene ring, a condensed aromatic ring having 8 or more carbon atoms, a heterocyclic ring condensed with an aromatic ring, and connected benzene rings in which two or more benzene rings are connected.

The condensed aromatic ring having 8 or more carbon atoms is an aromatic ring formed by condensation of two or more benzene rings or an aromatic compound having at least 8 or more carbon atoms whose ring is formed by at least one type of aromatic ring and an alicyclic hydrocarbon condensed with the aromatic ring. Specific examples thereof include naphthalene, anthracene, fluorene, phenanthrene, and acenaphthene.

The heterocyclic ring condensed with an aromatic ring is a compound containing a condensed ring in which an aromatic compound (preferably a benzene ring) not containing a hetero atom and a cyclic compound containing a hetero atom are condensed with each other. Here, the cyclic compound containing a hetero atom is preferably a 5-membered ring or a 6-membered ring. As the hetero atom, a nitrogen atom, an oxygen atom, or a sulfur atom is preferred. The cyclic compound containing a hetero atom may contain plural hetero atoms. In this case, the hetero atoms may be the same as each other or different from each other. Specific examples of the heterocyclic ring condensed with an aromatic ring include phthalimide, acridone, carbazole, benzoxazole, and benzothiazole.

Specific examples of a monomer that can form a hydrophobic structural unit (a1) containing a monovalent group derived from the benzene ring, the condensed aromatic ring having 8 or more carbon atoms, the heterocyclic ring condensed with an aromatic ring, or the two or more connected benzene rings are shown below, but the invention is not restricted to the following examples.

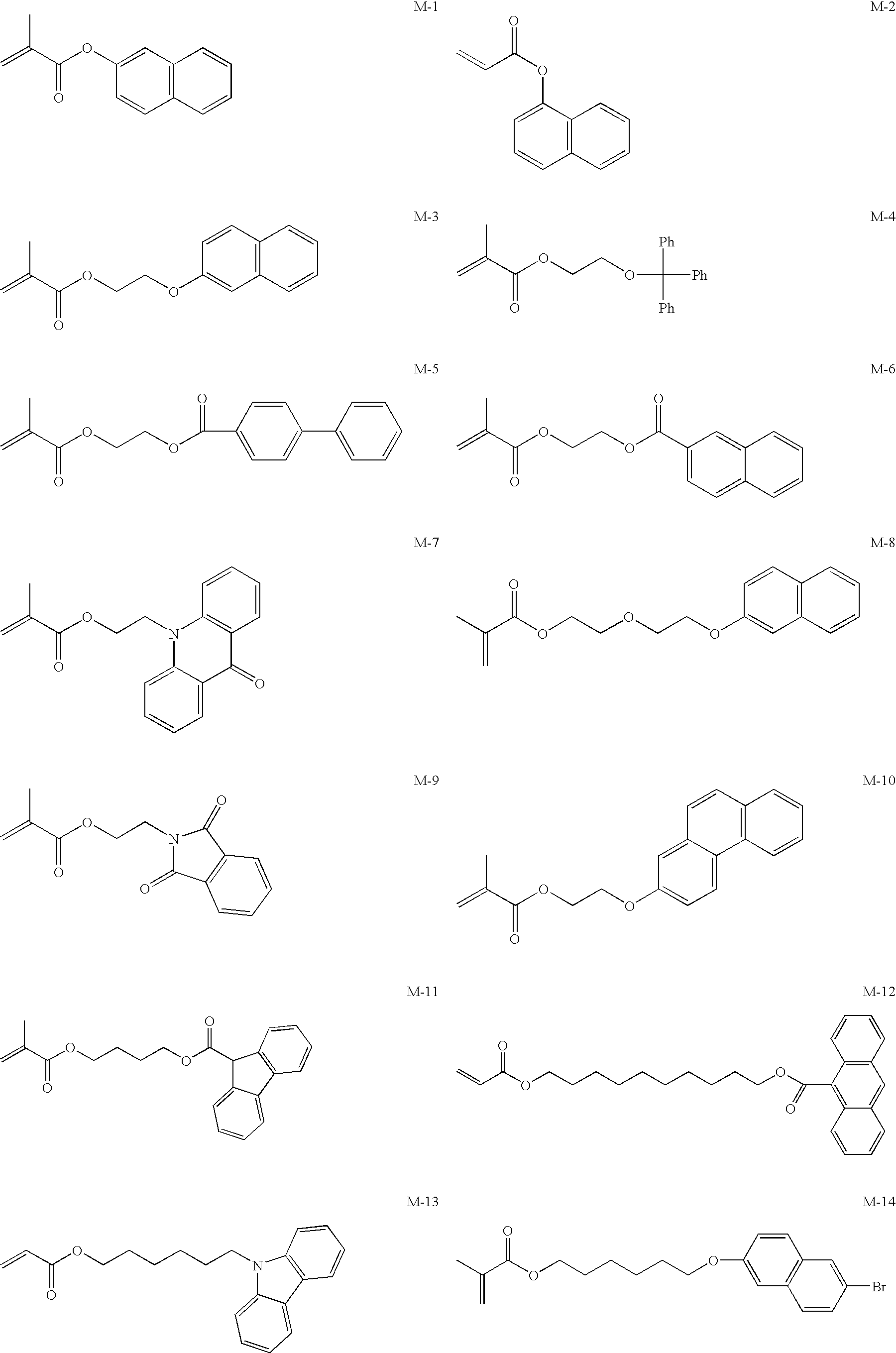

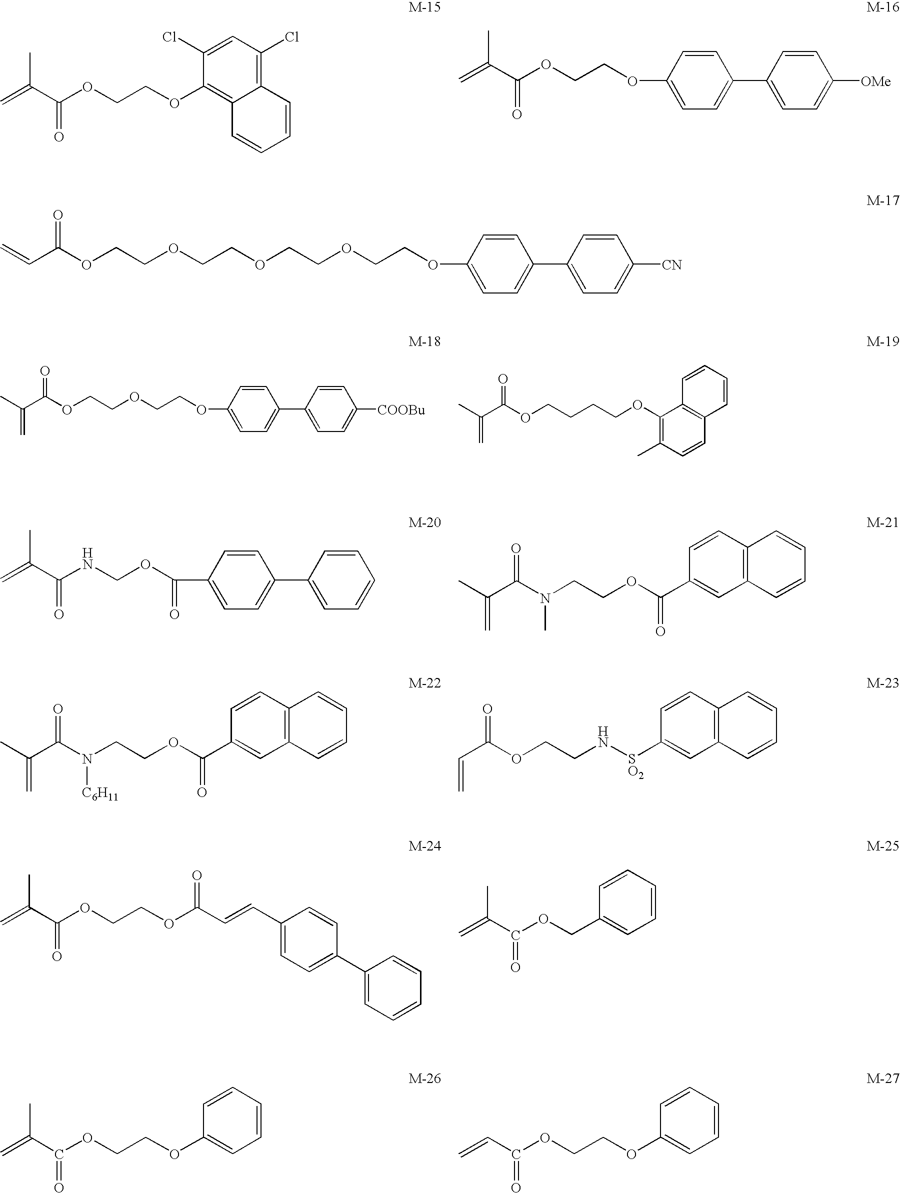

In the invention, the hydrophobic structural unit (a1) having an aromatic ring which is not directly bonded to the atom belonging to the main chain of the resin (A), is preferably a structural unit derived from one or more of benzyl methacrylate, phenoxyethyl acrylate or phenoxyethyl methacrylate, in consideration of the dispersion stability.

Hydrophobic Structural Unit (a2) Derived from Alkyl Ester of Acrylic Acid or Methacrylic Acid Having 1 to 4 Carbon Atoms

In the resin (A), it is preferable that a hydrophobic structural unit (a2) derived from an alkyl ester of acrylic acid or methacrylic acid having 1 to 4 carbon atoms is contained at an amount of at least 15 mass % or more. The “alkyl ester of acrylic acid or methacrylic acid having 1 to 4 carbon atoms” refers to an alkyl ester of acrylic acid or methacrylic acid wherein the alkyl ester has 1 to 4 carbon atoms. The amount of the hydrophobic structural unit (a2) is more preferably form 20 mass % to 60 mass %, and still more preferably from 20 mass % to 50 mass %.

Specific examples of such a (meth)acrylic ester include methyl(meth)acrylate, ethyl(meth)acrylate, (iso)propyl(meth)acrylate, and (iso or tertiary)butyl(meth)acrylate.

The number of the carbon atoms of the alkyl group is preferably from 1 to 4, and more preferably from 1 to 2.

Hydrophilic Structural Units (b)

The hydrophilic structural units (b) as a component of the resin (A) in the invention will be described below.

The content of the hydrophilic structural units (b) is from more than 0 mass % to 15 mass %, preferably from 2 mass % to 15 mass %, more preferably from 5 mass % to 15 mass %, and even more preferably from 8 mass % to 12 mass %, with respect to the total mass of the resin (A).

As hydrophilic structural units (b), the resin (A) includes at least a hydrophilic structural unit (b1) derived from acrylic acid and/or methacrylic acid. Further, the resin (A) may include a hydrophilic structural unit (b2) other than the hydrophilic structural unit derived from acrylic acid and/or methacrylic acid.

Hydrophilic Structural Unit (b1)

The content of the hydrophilic structural unit (b1) is adjusted based on the content of the after-mentioned structural unit (b2) or based on the amount of the hydrophobic structural units (a), or based on both of the above.

The resin (A) in the invention contains the hydrophilic structural units (a) at an amount of more than 80 mass % and the hydrophilic structural units (b) at an amount of 15% or less. The composition of the resin (A) is determined based on the respective contents of the hydrophobic structural units (a1) and (a2), the hydrophilic structural units (b1) and (b2), and the structural unit (c).

For example, when the resin (A) consists only of the hydrophobic structural units (a1) and (a2) and the hydrophilic structural units (b1) and (b2), the content of the structural unit (b1) derived from acrylic acid and/or methacrylic acid can be obtained by the following formula:

Content of the structural unit(b1)=100−(mass % of the hydrophobic structural units(a1)and(a2))−(mass % of the structural unit(b2))

In this case, the sum of (b1) and (b2) is 15 mass % or less.

Further, when the resin (A) consists of the hydrophobic structural units (a1) and (a2), the hydrophilic structural unit (b1), and the structural unit (c), the content of the hydrophilic structural unit (b1) can be obtained by the following formula:

Content of the structural unit(b1)=100−(mass % of the hydrophobic structural units(a1)and(a2))−(mass % of the structural unit(c))

The resin (A) may consist only of the hydrophobic structural unit (a1), the hydrophobic structural unit (a2), and the hydrophilic structural unit (b1).

The hydrophilic structural unit (b1) can be obtained by polymerizing acrylic acid and/or methacrylic acid.

Either acrylic acid or methacrylic acid may be used singly, or a mixture of acrylic acid and methacrylic acid may be used.

The acid value of the resin (A) of the invention is preferably from 30 mg KOH/g to 100 mg KOH/g, more preferably 30 mg KOH/g to less than 85 mg KOH/g, and particularly preferably 50 mg KOH/g to less than 85 mg KOH/g, in consideration of the pigment dispersibility and storage stability.

Here, the acid value is defined as the weight (mg) of KOH required for completely neutralizing 1 g of the resin (A), and can be measured in accordance with the method described in JIS Standard (JIS-K0070 (1992); the disclosure of which is incorporated by reference herein).

Structural Unit (b2)

The structural unit (b2) preferably contains a nonionic hydrophilic group. The structural unit (b2) may be introduced into the resin (A) by polymerizing monomers (monomer groups) containing a monomer corresponding to the structural unit (b2), or by introducing a hydrophilic functional group into the polymer chain after formation of a polymer by polymerization.

The monomer fofororming the structural unit (b2) is not specifically limited, as long as the monomer contains a functional group which can form a polymer, and a nonionic hydrophilic functional group, and any known monomers can be used. In consideration of the availability, handling properties and versatility, vinyl monomers are preferable.

Examples of the vinyl monomers include (meth)acrylic acid esters, (meth)acrylamides, and vinyl esters having a hydrophilic functional group.

Examples of the hydrophilic functional group include a hydroxyl group, an amino group, an amide group (in which the nitrogen atom is non-substituted), alkyleneoxide polymers, which will be described later, such as polyethylene oxide or polypropylene oxide.

Among these vinyl monomers, hydroxyethyl(meth)acrylate, hydroxybutyl(meth)acrylate, (meth)acrylamide, aminoethyl acrylate, aminopropyl acrylate, and (meth)acrylic acid esters containing an alkyleneoxide polymer, are particularly preferable.

It is preferable for the structural unit (b2) to contain a hydrophilic structural unit having an alkyleneoxide polymer structure.

The alkylene in the alkyleneoxide polymer is preferably an alkylene having 1 to 6 carbon atoms, more preferably 2 to 6 carbon atoms, and even more preferably 2 to 4 carbon atoms, in consideration of hydrophilicity.

The polymerization degree of the alkyleneoxide polymer is preferably from 1 to 120, more preferably from 1 to 60, and particularly preferably from 1 to 30.

It is also preferable that the structural unit (b2) is a hydrophilic structural unit containing a hydroxyl group.

The number of the hydroxyl groups in the structural unit (b2) is not specifically limited, but the number of the hydroxyl groups is preferably from 1 to 4, more preferably from 1 to 3, and particularly preferably from 1 to 2, in consideration of the hydrophilicity of the resin (A) and the compatibility with a solvent or other monomers at the time of polymerization.

Structural Unit (c)

As described above, the resin (A) of the invention may contain a structural unit (c) that is different from the hydrophobic structural units (a1) and (a2) and the hydrophilic structural unit (b) (hereinafter, sometimes referred to as simply a “structural unit (c)”).

The structural unit (c) different from the hydrophobic structural units (a1) and (a2) and the hydrophilic structural unit (b) is a structural unit (c) having a structure different from all of the structures of the above-mentioned structural units (a1), (a2), and (b). The structural unit (c) is preferably a hydrophobic structural unit.

When the structural unit (c) is a hydrophobic structural unit, the structural unit (c) has to be different from the hydrophobic structural units (a1) and (a2).

The content of the structural unit (c) is preferably 35 mass % or less, more preferably 20 mass % or less, and even more preferably 15 mass % or less, with respect to the total mass of the resin (A).

The structural unit (c) can be introduced into the resin (A), for example by polymerizing monomers (monomer groups) containing a monomer corresponding to the structural unit (c), or by introducing a hydrophobic functional group into the polymer chain after formation of a resin by polymerization.

When the structural unit (c) is a hydrophobic structural unit, any known monomer may be used without limitation, as long as the monomer contains a functional group capable of forming a polymer and a hydrophobic functional group.

The monomer capable of forming the hydrophobic structural unit is preferably selected from vinyl monomers such as (meth)acrylamides, styrenes or vinyl esters, in consideration of availability, handling properties and versatility.

Examples of the (meth)acrylamides include N-cyclohexyl(meth)acrylamide, N-(2-methoxyethyl)(meth)acrylamide, N,N-diallyl(meth)acrylamide and N-allyl(meth)acrylamide.

Examples of the styrenes include styrene, methylstyrene, dimethylstyrene, trimethylstyrene, ethylstyrene, isopropylstyrene, n-butylstyrene, tert-butylstyrene, methoxystyrene, butoxystyrene, acetoxystyrene, chlorostyrene, dichlorostyrene, bromostyrene, and chloromethylstyrene; hydroxystyrene protected by a group (for example, t-Boc) that can be deprotected by an acidic material; methyl vinylbenzoate, α-methylstyrene, and vinyl naphthalene. Among them, styrene and α-methylstyrene are preferable

Examples of the vinyl esters include vinyl esters such as vinyl acetate, vinyl chloroacetate, vinyl propionate, vinyl butyrate, vinyl methoxyacetate, and vinyl benzoate. Among them, vinyl acetate is preferable.

These monomers may be used singly, or in combination of two or more kinds thereof as a mixture.

The resin (A) in the invention may be a random copolymer in which the respective structural units are randomly introduced or a block copolymer in which the respective structural units are regularly introduced. When the resin (A) is a block copolymer, the order of introducing the respective structural units during the synthesis of the block polymer is not limited; further, the same structural unit may be used two or more times during the synthesis of the block copolymer. The resin (A) is preferably a random copolymer in consideration of the versatility and manufacturability.

The molecular weight of the resin (A) used in the invention is, in terms of a weight average molecular weight (Mw), preferably from 30,000 to 150,000, more preferably from 30,000 to 100,000, and still more preferably from 30,000 to 80,000.

When the resin (A) has a molecular weight within the above ranges, steric repulsion effect that the resin (A) can exerts as a dispersant may improve and the time it takes for the resin (A) to adsorb to the pigment may be shortened due to steric effect, which is preferable.

Further, the molecular weight distribution (weight average molecular weight/number average molecular weight) of the resin (A) used in the invention is preferably from 1 to 6, and more preferably from 1 to 4.

It is preferable for the molecular weight distribution to be set within the above ranges, in consideration of the dispersion stability and ejection stability of ink. Each of the number average molecular weight and the weight average molecular weight used herein is a molecular weight value obtained by (i) measuring a molecular weight with a GPC analyzer using columns of TSKgel GMHxL, TSKgel G4000HxL and TSKgel G2000HxL (trade names, manufactured by Tosoh Corporation) and (ii) converting the measured value using polystyrene as a reference material; the solvent used for GPC is THF and the detection is conducted by a differential refractometer.

The resin (A) used in the invention can be synthesized by various polymerization methods, such as a solution polymerization, a precipitation polymerization, a suspension polymerization, a bulk polymerization, or an emulsion polymerization. The polymerization reaction can be performed by known operations such as a batch system, a semi-continuous system or a continuous system.

The polymerization initiation method may be a method of using a radical initiator or a method of irradiating light or radiation, for example. These polymerization methods and the polymerization initiation methods are described, for example, in Teiji Tsuruta, Kobunshi Gousei Houhou (Polymer Synthesis Method), revised edition (Nikkan Kogyo Shimbun (1971)) and Takayuki Otsu and Masayoshi Kinoshita, Koubunshi Gousei-no Jikken-ho (Experimental Method of Polymer Synthesis), (Kagaku-Dojin (1972)), pp. 124-154.

Among these polymerization methods, the solution polymerization method using a radical initiator is particularly preferable. Examples of the solvent used in the solution polymerization method include ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, and 1-butanol.

These organic solvents may be used singly, or may be used in the form of a mixture of two or more kinds thereof, or may be mixed with water and used as a mixed solvent.

The polymerization temperature should be set in consideration of, for example, the molecular weight of the polymer to be formed and the kind of the initiator. In general, the polymerization temperature is from about 0° C. to about 100° C. It is preferable to perform polymerization at a temperature of from 50° C. to 100° C.

The reaction pressure can be suitably selected, and is usually from about 1 kg/cm² to about 100 kg/cm², and is preferably from about 1 kg/cm² to about 30 kg/cm². The reaction time may be from about 5 hours to about 30 hours. The obtained resin may be purified by reprecipitation or the like.

Preferable examples of the resin (A) of the invention are shown below, but the invention is not limited thereto.

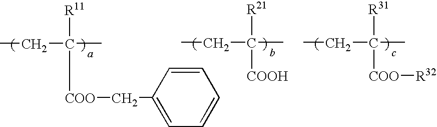

| | R¹¹ | R²¹ | R³¹ | R³² | a | b | c | Mw |
|---|---|---|---|---|---|---|---|---|
| B-1 | CH₃ | CH₃ | CH₃ | —CH₃ | 60 | 10 | 30 | 46000 |
| B-2 | H | H | H | —CH₃ | 60 | 10 | 30 | 50000 |
| B-3 | CH₃ | CH₃ | CH₃ | —CH₂CH₃ | 61 | 10 | 29 | 43000 |
| B-4 | CH₃ | CH₃ | CH₃ | —CH₂CH₂CH₂CH₃ | 61 | 9 | 30 | 51000 |
| B-5 | CH₃ | CH₃ | CH₃ | —CH₂(CH₃)CH₃ | 60 | 9 | 31 | 96000 |
| B-6 | H | H | H | —CH₂(CH₃) (CH₃)CH₃ | 60 | 10 | 30 | 32000 |
| B-7 | CH₃ | CH₃ | CH₃ | —CH₂CH(CH₃)CH₃ | 60 | 5 | 30 | 75000 |

a, b and c each represent a compositional ratio (mass %)

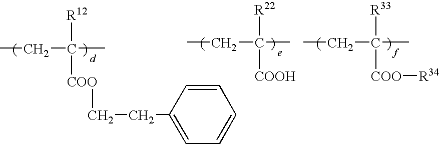

| | R¹² | R²² | R³³ | R³⁴ | d | e | f | Mw |
|---|---|---|---|---|---|---|---|---|
| B-8 | CH₃ | CH₃ | CH₃ | —CH₃ | 55 | 12 | 33 | 31000 |
| B-9 | H | H | H | —CH₂CH(CH₃)CH₃ | 70 | 10 | 20 | 34600 |

d, e and f each represent a compositional ratio (mass %)

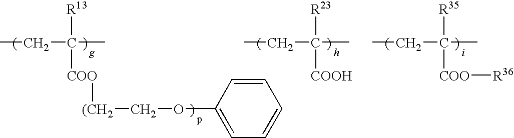

| | R¹³ | p | R²³ | R³⁵ | R³⁶ | g | h | i | Mw |
|---|---|---|---|---|---|---|---|---|---|
| B-10 | CH₃ | 1 | CH₃ | CH₃ | —CH₃ | 60 | 9 | 31 | 35500 |
| B-11 | H | 1 | H | H | —CH₂CH₃ | 69 | 10 | 21 | 41200 |
| B-12 | CH₃ | 2 | CH₃ | CH₃ | —CH₃ | 70 | 11 | 19 | 68000 |
| B-13 | CH₃ | 4 | CH₃ | CH₃ | —CH₂(CH₃)CH₃ | 70 | 7 | 23 | 72000 |
| B-14 | H | 5 | H | H | —CH₃ | 70 | 10 | 20 | 86000 |
| B-15 | H | 5 | H | H | —CH₂CH(CH₃)CH₃ | 70 | 2 | 28 | 42000 |

g, h and i each represent a compositional ratio (mass %)

B-16

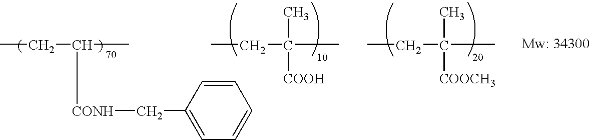

| | | Mw |
|---|---|---|
| B-17 | 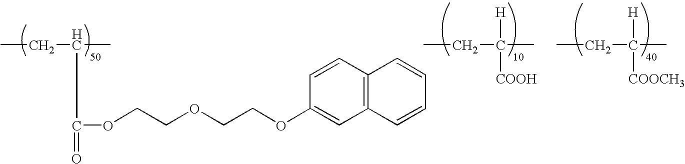 | 72400 |
| B-18 | 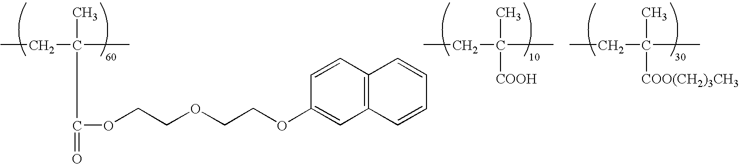 | 33800 |
| B-19 | 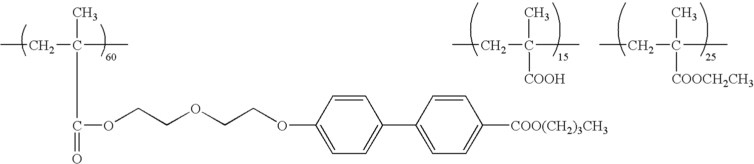 | 39200 |
| B-20 | 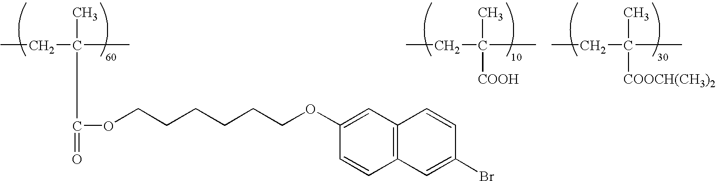 | 55300 |

Ratio of Resin Dispersant (Resin (A)) to Pigment

The ratio (weight ratio) of a resin dispersant (resin (A)) to a pigment (resin dispersant (resin (A))/pigment) is preferably from 25/100 to 140/100, and more preferably from 25/100 to 50/100. When the ratio of resin dispersant is 25/100 or more, the dispersion stability and resistance to rubbing tend to be improved. When the ratio of the resin dispersant is 140/100 or less, the dispersion stability tends to be improved as well.

The weight average molecular weight of the resin dispersant (resin (A)) of the invention is preferably in from 2,000 to 60,000.

Polymer Latex

In the ink used in the invention, a latex of resin particles (hereinafter sometimes referred to as polymer particles) is contained in view of imparting fixability, resistance to rubbing and cohesiveness, which prevents interference among applied ink droplets.

Polymer particles usable in the invention include a latex of the following: an acrylic resin, a vinyl acetate resin, a styrene-butadiene resin, a vinyl chloride resin, an acryl-styrene resin, a butadiene resin, a styrene resin, a crosslinked acrylic resin, a crosslinked styrene resin, a benzoguanamine resin, a phenol resin, a silicone resin, an epoxy resin, a urethane resin, a paraffin resin or a fluororesin Among these resins, a latex of an acrylic resin, an acryl-styrene resin, a styrene resin, a crosslinked acrylic resin, or a crosslinked styrene resin is preferable.

In consideration of the stability of the ink composition, the weight average molecular weight of the resin in the polymer particles is preferably from 10,000 to 200,000, and more preferably from 100,000 to 200,000.

The average particle diameter of the resin particles is preferably from 10 nm to 1 μm, more preferably from 10 nm to 200 nm, even more preferably from 20 nm to 100 nm and particularly preferably from 20 nm to 50 nm.

The addition amount of the polymer particles in terms of solid content is preferably from 0.5 mass % to 20 mass %, more preferably from 3 mass % to 20 mass %, and even more preferably from 5 mass % to 15 mass %, with respect to the total amount of the ink, in consideration of fixability, the resistance to rubbing, and the viscosity of the ink.

In consideration of the preservation stability of the ink composition, the glass transition temperature Tg of the resin particles is preferably 30° C. or more, more preferably 40° C. or more, and even more preferably 50° C. or more. The glass transition temperature Tg of the resin particles is preferably 80° C. or less from the viewpoint of imparting the resistance to rubbing by thermal fixing.

The particle size distribution of the polymer particles is not specifically restricted. Therefore, a latex with a broad particle size distribution and a latex with a monodispersed particle size distribution are both usable. Moreover, two or more kinds of polymer particles each having.a monodispersed particle size distributions may be mixed and used as a mixture.

The ratio (by mass) of the polymer particles to the pigment in the ink is preferably 0.5 or higher in view of improving the resistance to rubbing, and is more preferably 0.7 or higher, and further preferably 1.0 or higher. From the viewpoint of ensuring the ejection reliability, the ratio (by mass) of the polymer particles to the pigment is preferably 5 or lower.

Other Components

The ink used in the invention may contain other additives. Examples of other additives include known additives such as a surfactant, a ultraviolet absorber, an ant-fading agent, an antifungal agent, a pH adjuster, an antirust agent, an antioxidant, an emulsion stabilizer, an antiseptic agent, a defoaming agent, a viscosity adjustment agent, a dispersion stabilizer or a chelating agent.

Examples of the surfactant include a nonionic surfactant, a cationic surfactant, an anionic surfactant and a betaine surfactant. In order for the ink to be satisfactorily applied by inkjet system, the addition amount of the surfactant is such an amount that the surface tension of the ink of the invention is adjusted preferably to a range of from 20 mN/m to 60 mN/m, more preferably from 20 mN/m to 45 mN/m, and still more preferably from 25 mN/m to 40 mN/m.

As the surfactant in the invention, a compound having a structure in which a hydrophilic moiety and a hydrophobic moiety are included in a molecule can be effectively used. Any of an anionic surfactant, a cationic surfactant, an amphoteric surfactant, and a nonionic surfactant can be used. Furthermore, the above-mentioned polymer substance (polymer dispersant) is also usable as a surfactant.

Examples of the anionic surfactant include sodium dodecylbenzene sulfonate, sodium lauryl sulfate, a sodium alkyl diphenylether disulfonate, a sodium alkylnaphthalene sulfonate, a sodium dialkyl sulfosuccinate, sodium stearate, potassium oleate, sodium dioctylsulfosuccinate, a sodium polyoxyethylene alkylether sulfate, a sodium polyoxyethylene alkylphenylether sulfate, sodium dialkylsulfosuccinate, sodium stearate, sodium oleate, and sodium t-octylphenoxyethoxy-polyethoxyethyl sulfate. The anionic surfactant may be used singly, or in combination of two or more thereof.

Examples of the nonionic surfactant include acetylenediol derivatives such as an acetylenediol ethyleneoxide adducts, polyoxyethylene lauryl ether, polyoxyethylene octyl phenyl ether, polyoxyethylene oleyl phenyl ether, polyoxyethylene nonyl phenyl ether, oxyethylene-oxypropylene block copolymer, t-octyl phenoxyethyl polyethoxyethanol, and nonylphenoxyethyl polyethoxyethanol. The nonionic surfactant may be used singly, or in combination of two or more thereof.

Examples of cationic surfactant include a tetraalkyl ammonium salt, an alkylamine salt, a benzalkonium salt, an alkylpyridinium salt, and an imidazolium salt. Specific examples include dihydroxyethyl stearylamine, 2-heptadecenyl-hydroxyethyl imidazoline, lauryldimethyl benzyl ammonium chloride, cetyl pyridinium chloride, and stearamide methylpyridium chloride.

In view of preventing interference among applied ink droplets, nonionic surfactants are preferable, and in particular, acetylenediol derivatives are preferable.

The addition amount of the surfactants to be added to the ink is not specifically limited, but is preferably from 0.1 mass % or more, more preferably from 0.5 mass % to 10 mass %, and even more preferably from 1 mass % to 3 mass %.

Examples of the ultraviolet absorber include a benzophenone ultraviolet absorber, a benzotriazole ultraviolet absorber, a salicylate ultraviolet absorber, a cyanoacrylate ultraviolet absorber, and a nickel complex salt ultraviolet absorber.

As anti-fading agents, various organic and metal complex anti-fading agents can be used. Organic anti-fading agents include hydroquinones, alkoxyphenols, dialkoxyphenols, phenols, anilines, amines, indans, chromanes, alkoxy anilines, and heterocycles. Examples of the metal complexes include a nickel complex and a zinc complex.

Examples of the antifungal agent include sodium dehydroacetate, sodium benzoate, sodium pyridinethione-1-oxide, ethyl p-hydroxybenzoate, 1,2-benzisothiazoline-3-one, sodium sorbate, and sodium pentachlorophenol. The content of antifungal agent in the ink is preferably from 0.02 mass % to 1.00 mass %.

The pH adjuster is not specifically limited as long as the pH adjuster can adjust a pH value to a desired value without exerting an adverse influence on a recording ink to which the pH adjuster is added. The pH adjuster may be selected appropriately in accordance with the purpose. Examples of the pH adjuster include alcohol amines such as diethanlol amine, triethanol amine, or 2-amino-2-ethyl-1,3-propanediol; alkali metal hydroxides such as lithium hydroxide, sodium hydroxide, or potassium hydroxide; ammonium hydroxides such as ammonium hydroxide or quaternary ammonium hydroxide; phosphonium hydroxide; and alkali metal carbonates.

Examples of the antirust agent include acid sulfite, sodium thiosulfate, ammonium thiodiglycolate, diisopropyl ammonium nitrite, pentaerythritol tetranitrate, and dicyclohexyl ammonium nitrite.

Examples of the antioxidant include phenolic antioxidants (including hindered phenol antioxidants), amine antioxidants, sulfur antioxidants, and phosphorus antioxidants.

Examples of the chelating agent include sodium ethylenediamine tetraacetate, sodium nitrilotriacetate, sodium hydroxyethyl ethylenediamine triacetate, sodium diethylenetriamine pentaacetate, and sodium uramil diacetate.

Physical Property of Ink

The surface tension of the ink of the invention is preferably from 20 mN/m to 60 mN/m in consideration of ink ejecting stability. The surface tension is more preferably from 20 mN/m to 45 mN/m, and still more preferably from 25 mN/m to 40 mN/m.

The viscosity of the ink at 20° C. is preferably from 1.2 mPa·s to 15.0 mPa·s, more preferably from 2 mPa·s to less than 13 mPa·s and still more preferably from 2.5 mPa·s to less than 10 mPa·s.

Ink Set

When a full-color image is formed by the image forming method according to the invention, an ink set including at least a magenta ink, a cyan ink and a yellow ink is used. When inks of plural colors are used in the image forming method according the invention, it is preferable that each of the inks contains a pigment, water, a water-soluble solvent and polymer particles and satisfies the condition of Formula (1).

Further, the ink set of the invention may be used in the form of an ink cartridge in which the respective inks are accommodated integrally or in the form of a set of ink cartridges in which the respective inks are accommodated independently; the ink cartridge or the set of ink cartridges is preferable from the viewpoint of ease of handling. An ink cartridge containing an ink set or a set of ink cartridges containing an ink set is known in the art, and can be produced by appropriately using known methods.

In an embodiment (a first embodiment) of the ink set used in the invention, the ink set includes plural inks having respectively different colors.

Further, in another embodiment (second embodiment) of the ink set, the ink set includes the inks of plural colors (hereinafter sometimes referred to as “first inks”) and another ink (hereinafter sometimes referred to as “second ink a “second ink”) containing an aggregation promoter for promoting the aggregation of the pigments in the first inks.

The ink set of the first embodiment can be used for forming a full-color image since the ink set includes plural inks of respectively different colors. Further, the ink set of the first embodiment may have good liquid stability and ink ejecting property, and, when the ink set is used, curl of an inkjet recording medium after application of inks may be suppressed.

In order to form a full-color image, the plural ink compositions having respectively different colors preferably include a magenta color ink, a cyan color ink, and a yellow color ink. The plural ink compositions optionally include a black color ink in order to control a color tone. Moreover, the plural ink compositions optionally include at least one of a red ink, a green ink, a blue ink, a white ink, or an ink having a special color used in the printing field, which are different from the yellow, magenta and cyan inks.

The ink set of the second embodiment includes the first inks having different colors and a second ink containing a pigment aggregation promoter; therefore, the aggregation of the pigment is promoted when some or all of the first inks and the second ink are mixed on a recording medium, so that the pigment applied onto the recording medium is likely to remain on the surface of the recording medium and so that color formation of an image to be formed is excellent.

When an image is formed using the ink set of the second embodiment, the method of applying the first inks and the second ink onto a recording medium is not specifically restricted. The second ink composition may be applied onto the recording medium after the first inks are applied onto the recording medium, or vice versa.

The constitution of the second ink composition may be the same as that of the first ink, except that the second ink contains the pigment aggregation promoter in place of the pigment.

The aggregation promoter contained in the second ink is not particularly limited as long as it promotes aggregation of a pigment. In particular, an acid is preferable in terms of aggregation speed.

The acid may be either an inorganic acid or an organic acid. The acid is preferably selected from polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furan carboxylic acid, pyridine carboxylic acid, coumalic acid, thiophene carboxylic acid, nicotinic acid, or the derivatives or salts thereof. These compounds may be used singly, or two or more kinds thereof may be used in combination.

An ink satisfying Formula (1) can be obtained by appropriately adjusting the addition amounts of the pigment, water, water-soluble solvent and polymer particles and the properties of the respective components. For example, the following techniques, each of which has a tendency to lower the ratio of A_{d}/A_{w}, may be combined to form an ink satisfying Formula (1):

(1) increase the ratio (by mass) of the polymer particles to the pigment (polymer particles/pigment);

(2) increase the proportion of a water-soluble solvent having a low SP value;

(3) decrease the total amount of the water-soluble solvent;

(4) decrease the glass transition temperature of the polymer particles; and

(5) increase the temperature of the ink at the time of ejection.

Image Forming Method

The image forming method according to the invention includes an ink ejection step of ejecting the ink described above to a recording medium and an adhered solid removing step of removing an adhered ink solid from a nozzle face of a head that ejects the ink. The image forming method may include other additional steps as necessary.

In a preferable inkjet recording method in the invention, energy is supplied to an inkjet recording ink to form an image on a known image receiving material such as plain paper, resin coated paper, inkjet paper such as those described in JP-A Nos. 8-169172, 8-27693, 2-276670, 7-276789, 9-323475, 62-238783, 10-153989, 10-217473, 10-235995, 10-217597 and 10-337947, a film, electrophotographic common paper, fabrics, glass, metal or ceramics. In addition, as an inkjet recording method applied to the invention, the inkjet recording method described in the paragraphs [0093] to [0105] of JP-A No. 2003-306623 is preferable.

The inkjet head (hereinafter sometimes simply referred to as “head”) may be a known inkjet head, and may be, for example, of a continuous head or a dot-on-demand head. Among dot-on-demand heads, a thermal head preferably has a movable valve for ejection as described in JP-A No. 9-323420. In a case of a piezo head, piezo heads described in European Patent Application Laid-Open (EP-A) Nos. 277,703 and 278,590 may be used, for example. The head preferably has a temperature control function so as to allow control of the ink temperature. At ink ejection, the ink temperature is preferably controlled such that the variation of the ink viscosity falls within ±5%. The driving frequency is preferably from 1 kHz to 500 kHz. The shape of the nozzle is not necessarily circular, and may be elliptical, rectangular, or any other shape. The nozzle diameter is preferably from 10 μm to 100 μm. The opening at the nozzle is not necessarily a perfect circle. When the opening at the nozzle is not perfectly circular, the nozzle diameter means the diameter of a hypothetical circle having the same area as that of the opening.

The temperature of the ink at the time of ink ejection in the ink ejection step is preferably 30° C. or more from the viewpoint of controlling the ink temperature at ejection and improving removability by wiping, and is more preferably 35° C. or more. In consideration of ink stability and ejection reliability, the ink temperature at the time of ejection is preferably 70° C. or less.

The nozzle face of the head has preferably been subjected to an ink repelling treatment so as to lower the adhesiveness of ink to the nozzle face. The ink repelling property can be particularly improved by covering the nozzle face with a perfluoro polymer such as PTFT, PFA or FEP.

In the adhered solid removal, an adhered ink solid is removed from the nozzle face of the head. The method for removing the adhered ink solid derived from ink on the nozzle face is not particularly limited, and is preferably a method of rubbing (wiping) the nozzle face with a wiper blade so as to scrape off the adhered ink solid. The material of the wiper blade is preferably a rubber having elasticity, and examples thereof include butyl rubber, chloroprene rubber, ethylene-propylene rubber, silicone rubber, urethane rubber and nitrile rubber. The wiper blade may be coated with a fluororesin or the like, which imparts an ink repelling property to the wiper blade.

In the image forming method according to the invention, the adhered ink solid derived from ink on the nozzle face can be easily scraped off as a solid since the ink specified above is used.

The image forming method according to the invention may further include, after image formation by ejection of ink onto a recording medium in the ink ejection step, a step (heat-fixing step) of heating the recording medium to fix the image.

The heat-fixing step is not particularly limited as long as the latex particles contained in the ink used in the inkjet recording method are fused and fixed in the heat-fixing step, and may be appropriately selected in accordance with the purpose.

Further, the image forming method according to the invention may include other additional steps. The additional steps are not particularly limited, and a drying and removal step and/or a heat-fixing step may be selected appropriately in accordance with the purpose.

The drying and removal step is not particularly limited as long as the ink solvent (water and the water-soluble solvent) contained in the ink ejected to the recording medium is removed by drying in the step, and may be appropriately selected in accordance with the purpose.

The heat-fixing step is not particularly limited as long as the polymer particles contained in the ink are softened in the step and resistance to rubbing is imparted to the formed image thereby, and may be appropriately selected in accordance with the purpose.

The recording medium used in the invention is not particularly limited, and may be plain paper, high-quality paper or coated paper, for example.

### EXAMPLES

Hereinafter, the invention will be described in more detail with reference to the examples, but the invention is not limited to examples. Further, “parts” and “%” indicate quantities in terms of mass, unless otherwise specified.

### Synthesis Example

Synthesis of Resin Dispersant P-1

A resin dispersant P-1 was synthesized according to the following scheme.

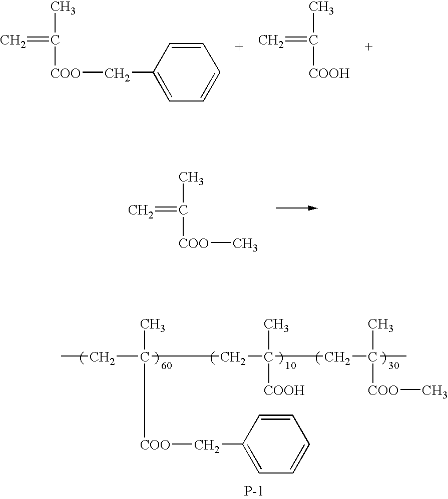

Methyl ethyl ketone (88 g) was placed in a 1000 ml three-neck flask equipped with a stirrer and a condenser tube, and heated to 72° C. under a nitrogen atmosphere. Separately, 0.85 g of dimethyl-2,2′-azobisisobutyrate, 60 g of benzyl methacrylate, 10 g of methacrylic acid, and 30 g of methyl methacrylate were dissolved in 50 g of methyl ethyl ketone to form a solution. The solution is added dropwise to the liquid in the flask over three hours. After the dropwise addition was completed, the reaction was further continued for one hour. Then, a solution obtained by dissolving 0.42 g of dimethyl 2,2′-azobisisobutyrate in 2 g of methyl ethyl ketone was added to the reaction solution, and the reaction solution was heated to 78° C. and heated at this temperature for 4 hours. The obtained reaction solution was reprecipitated twice with an excess quantity of hexane, and the precipitated resin was dried, whereby 96 g of dispersant P-1 was obtained.

Subsequently, the composition of the obtained resin was identified with ¹H-NMR. The weight average molecular weight (Mw) was determined by a GPC method, and was found to be 44,600. Furthermore, the acid value of the polymer was obtained in accordance with the method described in JIS Standard (JIS-K0070 (1992), the disclosure of which is incorporated by reference herein), and was found to be 65.2 mgKOH/g.

Dispersion of Pigment-Containing Resin Particles

10 parts by mass of Pigment blue 15:3 (Phthalocyanine Blue A220 (trade name), manufactured by Dainichiseika Color & Chemicals Mfg. Co., Ltd.), 5 parts by mass of P-1 resin dispersant (described in the following Table 1), 42 parts by mass of methyl ethyl ketone, 5.5 parts of an aqueous solution of NaOH (1N), and 87.2 parts of ion-exchanged water were mixed, and the mixture was dispersed by a bead mill for 4 hours using zirconia beads with a diameter of 0.1 mmφ.

Methyl ethyl ketone was removed from the obtained dispersion at 55° C. under reduced pressure, and a part of the water was removed, whereby a dispersion 1 including pigment-containing resin particles with a pigment concentration of 10.2 mass % was obtained.

### Comparative Example 1

The following ingredients in the indicated amounts were mixed using the obtained dispersion of the pigment-containing resin particles, and the obtained mixture was filtered through a 5-μm membrane filter to prepare an ink.

| | | | |
|---|---|---|---|
| (1) | Pigment-containing resin particle dispersion 1 | 39.2 | parts |
| | described above | | |
| (2) | Ethylene glycol | 30 | parts |
| (3) | Diethyleneglycol monobutyl ether | 10 | parts |
| (4) | OLFIN F1010 (tradename, manufactured by | 1 | part |
| | Nisshin Chemical Industry Co., Ltd.) | | |

| | | |
|---|---|---|
| (5) | Ion-exchange water | Balance to |
| | | adjust the total |
| | | amount to 100 parts |

### Comparative Example 2

An ink was prepared in the same manner as in Comparative Example 1, except that 19 parts of JONCRYL 7640 (tradename, manufactured by BASF Japan Ltd.) having a Tg of 85° C. was further added and that the amount of ion-exchange water was adjusted to set the total amount to 100 parts.

### Example 1

The following ingredients in the indicated amounts were mixed using the obtained pigment-containing resin particle dispersion. The obtained mixture was filtered through a 5-μm membrane filter to prepare an ink.

| | | | |
|---|---|---|---|
| (1) | The pigment-containing resin particle dispersion 1 | 39.2 | parts |
| | obtained above | | |
| (2) | JONCRYL537J (tradename, manufactured by BASF | 17 | parts |
| | Japan Ltd.) having a Tg of 49° C. | | |
| (3) | NEWPOL GP-250 (tradename, manufactured by | 10 | parts |
| | Sanyo Chemical Industries Ltd.) | | |
| (4) | Diethyleneglycol monobutyl ether | 5 | parts |
| (5) | OLFIN E1010 (tradename, manufactured by | 1 | part |
| | Nisshin Chemical Industry Co., Ltd.) | | |

| | | |
|---|---|---|
| (6) | Ion-exchange water | Balance to |
| | | adjust the total |
| | | amount to 100 |
| | | parts |

### Example 2

An ink was prepared in the same manner as in Example 1, except that 18 parts of JONCRYL 538J (tradename, manufactured by BASF Japan Ltd.) having a Tg of 66° C. was used in place of JONCRYL 537J, that 20 parts of NEWPOL GP-400 (tradename, manufactured by Sanyo Chemical Industries Ltd.) was used in place of NEWPOL GP-250 and that the amount of water was adjusted to set the total amount to 100 pars.

### Example 3

An ink was prepared in the same manner as in Example 1, except that the amount of JONCRYL 537J was changed to 7 parts, that the amount of NEWPOL GP-250 was changed to 30 parts, that 5 parts of glycerin was used in place of 5 parts of diethyleneglycol monobutyl ether and that the amount of water was adjusted to set the total amount to 100 parts.

Evaluation

A_{d} and A_{w} of each of the inks obtained above were measured to obtain a ratio A_{d}/A_{w}. Each ink was also evaluated in terms of ease of maintenance of the inkjet recording apparatus, curl of the recording medium, and the unevenness and resistance to rubbing of the formed image. The evaluation methods and evaluation criteria are as described below. The obtained results are shown in Table 1.

Inkjet Recording Apparatus

DIMATIX MATERIAL PRINTER DMP-2831 (trade name, manufactured by Fuji Film Dimatix Inc.) that was equipped with a 10 pl ejection cartridge DMC-11610 (trade name, manufactured by Fuji Film Dimatix Inc.) and that was modified to allow liquid supply from the outside was used as an inkjet recording apparatus.

Recording Medium

The recording medium used was TOKUBISHI ART double-sided N paper (tradename, manufactured by Mitsubishi Paper Mills, Ltd.) (basis weight: 84.9 g/m²) on which the following colorless ink composition 1 (aggregation promoting liquid) had been applied in an amount of 5 g/m² and dried at 60° C. for one minute at a conveyance speed of 15 m/s.

The colorless ink composition 1 was prepared by mixing the following ingredients.

### Composition

| | |
|---|---|
| Citric acid | 15 g |
| OLFIN E1010 (manufactured by Nisshin | 1 g |
| Chemical Industry Co., Ltd.) | |
| Ion-exchange water | 84 g |

Evaluation of Ease of Maintenance

Ink jetting was conducted according to each of the following conditions. In each case, the nozzle face of the inkjet head was wiped with a wiper blade (hydrogenated NBR) after the ink jetting, and ink jetting was conducted again. Each ink was evaluated with respect to whether it satisfies each of the following conditions:
(1) Directly after 60 minutes of continuous ejection, wiping with the blade was conducted once, and the ink jetting ratio thereafter was 90% or more;
(2) After 1-minute of ejection, ejection was stopped for 30 minutes, and then wiping with the blade was conducted once, and ink jetting ratio thereafter was 90% or more; and
(3) Directly after 10 minutes of ejection, wiping with the blade was conducted once, and image unevenness was not observed in an image formed after the wiping.

### Method of Measuring Ink Ejection Ratio

When the test started, it was confirmed that all of the nozzles ejected inks. After the test including the maintenance treatment (wiping), the number of nozzles that continued to eject inks were counted, and the ejection ratio was calculated as follows:

Ejection ratio(%)=(number of nozzles ejecting inks after maintenance)/(total number of nozzles)×100

### Evaluation Criteria

A: all of the conditions (1) to (3) were satisfied

B: two of the conditions (1) to (3) were satisfied

C: one of the conditions (1) to (3) was satisfied

D: none of the conditions (1) to (3) was satisfied

Evaluation of Curl

A solid image was printed on the recording medium so as to give an applied ink amount of 5 g/m², and the recording medium after the printing was cut to make a strip of 5 mm×50 mm such that curling direction was the length direction (50 mm). The strip was left in conditions of 25° C. and 50% RH for 24 hours, and thereafter, the curvature (C) was measured.

### Evaluation Criteria

A: Curvature C did not exceed 20

B: Curvature C exceeded 20

### Method of Measuring Curvature

The sample strip having a size of 5 mm×50 mm, the length of 50 mm being in the curling direction, was measured with a curl measurement plate, and a curl value (C) was read. The curl of the sample was regarded as an arc of a circle with a radius of R, and the curl was calculated according to the equation, C=1/R(m).

Evaluation of Image Unevenness and Rubbing Resistance

A 5 cm×5 cm image was printed on the recording medium, followed by drying and further followed by fixing by heating at 100° C. for 10 seconds. Thereafter, evaluation was conducted based on the following criteria:

### Image Unevenness

A: image unevenness was not observed by visual inspection

B: image unevenness was observed by visual inspection

### Rubbing Resistance

The printed face of the print was rubbed in a reciprocal manner with TOKUBISHI ART double-sided paper N (tradename, having a basis weight of 84.9 g/m²) at a load of 2 kg/cm², and the reciprocal rubbing was repeated so that the reciprocal rubbing was conducted ten times in total. Then, the surface of the print and the surface of the paper used for rubbing were observed and evaluated with respect to the following items:

(1) Peeling of the printed image occurred and the base paper was partially seen

(2) Adhesion of colorant to the paper used for rubbing was observed

### Evaluation Criteria

A: neither item (1) nor item (2) was observed

B: either one of item (1) or item (2) was observed.

C: both of items (1) and (2) were observed

TABLE 1

| | | | Ratio of | | | | | |
|---|---|---|---|---|---|---|---|---|
| | | | Solvent | | | | | |
| | Tg of | Amount of | Having SP | | | | | |
| | Polymer | Water-soluble | Value of 27.5 | | Ease of | Image | | Rubbing |
| | Particles | Solvent | or Less | Ad/Aw | Maintenance | Unevenness | Curl | Resistance |
| Comparative | N.A. | 40% | 25% | 0.86 | B | B | B | C |
| Example 1 | | | | | | | | |
| Comparative | 85° C. | 40% | 25% | 0.21 | D | A | B | B |
| Example 2 | | | | | | | | |
| Example 1 | 49° C. | 15% | 100% | 0 | A | A | A | A |
| Example 2 | 66° C. | 25% | 100% | 0 | A | A | A | A |
| Example 3 | 49° C. | 35% | 86% | 0.06 | B | A | A | A |

According to the invention, an image forming method is provided which can ease the maintenance of a nozzle face of an inkjet recording head while maintaining the resistance to rubbing of a formed image.

All publications, patent applications, and technical standards mentioned in this specification are herein incorporated by reference to the same extent as if each individual publication, patent application, or technical standard was specifically and individually indicated to be incorporated by reference.

What is claimed is:

1. An image forming method, comprising:
ejecting an ink containing a pigment, water, a water-soluble solvent and polymer particles onto a recording medium; and
removing adhered ink solid from a nozzle face of a head that ejects the ink, wherein the ink satisfies the following Formula (1):
A_{d}/A_{w}≦0.1 Formula (1)
wherein, in Formula (1), A_{d} represents absorbance at λmax observed when 1 L of water is added to an ink residue obtained by drying 0.1 g of the ink for 24 hours in ambient conditions of 23° C. and relative humidity (RH) of 50%, and A_{w} represents absorbance at λmax observed when 1 L of water is added to 0.1 g of the ink.

2. The image forming method of claim 1, wherein the removing comprises wiping the nozzle face of the head with a wiper blade.

3. The image forming method of claim 1, wherein a ratio (by mass) of the polymer particles to the pigment in the ink is 0.5 or higher.

4. The image forming method of claim 1, wherein at least 90% by mass of the water-soluble solvent is a solvent having an SP value of 27.5 or less.

5. The image forming method of claim 1, wherein the content of the water-soluble solvent is from 5% by mass to 30% by mass with respect to the total amount of the ink.

6. The image forming method of claim 1, wherein the glass transition temperature of the polymer particles is 80° C. or less.

7. The image forming method of claim 1, wherein, in the ejecting, the temperature of the ink is 30° C. or higher.
